(19) United States
(12) Patent Application Publication
(10) Pub. No.: US 2026/0343392 A1
(43) Pub. Date: Oct. 29, 2026

(54) COMMUNICATION DEVICE, CONTROL METHOD, AND STORAGE MEDIUM

(71) Applicant: CANON KABUSHIKI KAISHA, Tokyo (JP)

(72) Inventor: TAKAFUMI NAKAJIMA, Tokyo (JP)

(21) Appl. No.: 19/653,607

(22) Filed: Apr. 21, 2026

(30) Foreign Application Priority Data
Apr. 23, 2025 (JP) 2025-071452

(51) Int. Cl. H04W 48/00; H04L 5/00; H04W 48/16

(52) U.S. Cl. CPC H04W 48/17; H04L 5/0048; H04W 48/16

(57) ABSTRACT

A communication device is capable of executing a service by directly connecting to another communication device, and the communication device includes an operation control unit configured to cause the communication device to simultaneously or alternately operate as a search device that searches for the service and as an advertising device that reports the service, and a transmission unit configured to transmit a first frame that includes first information indicating whether the communication device operates as the search device or as the advertising device and second information relating to connection setup with the another communication device in a case where the communication device simultaneously or alternately operates as the search device and as the advertising device.

### BACKGROUND

### Field of the Technology

The present disclosure relates to a communication device, a control method, and a storage medium.

### Description of the Related Art

With an increase in the amount of data to be communicated in recent years, the development of communication technology such as wireless local area networks (LANs) is progressing. As major communication standards of these wireless LANs, the IEEE (Institute of Electrical and Electronics Engineers) 802.11 series of standards is known. The IEEE 802.11 series of standards includes the IEEE 802.11a/b/g/n/ac/ax, etc. For example, in the IEEE 802.11ax, which is the latest standard, in addition to a peak throughput as high as 9.6 gigabits per second (Gbps) at the maximum, a technique for improving the communication speed under congested conditions is standardized by using Orthogonal Frequency Division Multiple Access (OFDMA).

Wi-Fi® Alliance, which has developed a certification program for wireless LAN devices, has developed a WFD standard that defines a procedure for establishing a communication link between STAs of a wireless LAN by exchanging communication parameters between the STAs without using an AP. Wi-Fi stands for “Wireless Fidelity”, AP stands for “Access Point”, STA stands for “station”, and WFD stands for “Wi-Fi Direct®”. STA may also be referred to as “non-AP STA”. The WFD communication is an example of P2P (Peer to Peer) communication, D2D (Device to Device) communication, or direct connection communication.

In WFD, to shorten the time from the discovery of a peer device to the establishment of a connection, a method for searching for a peer device by using an SDF is also being studied. SDFs are adopted in the Wi-Fi Aware standard, which is a standard for searching for services provided by devices. SDF stands for “Service Discovery Frame”. In the present specification and the drawings, the terms “discovery”, “search”, and “detection” may be interchangeable.

In WFD, a Service Discovery process is used as a process for discovering a peer device including a service. WO 2018/051633 proposes a technique for discovering a connection peer device by using the functions of two roles, which are an advertiser that reports a service supported thereby and a seeker that searches for a device that supports a service.

In addition, in the Wi-Fi standards, the Device Provisioning Protocol (DPP) standard has been proposed. In the proposal of the DPP standard, a method for establishing a secure connection with a connection peer device by using a Bootstrapping scheme has been proposed.

In the Bootstrapping scheme, first, two communication devices share a public key. After both the communication devices establish secure communication with each other based on the shared public key, the communication devices share information necessary for connecting to each other, and establish the connection. As a method for sharing the public key, for example, a sharing method using a QR code® has been proposed in the DPP standard. In the sharing method using a QR code, a device that performs a role of displaying a QR code and a device that performs a role of scanning the QR code are determined so as to share the public key.

In WFD, it is conceivable to adopt the connection method using SDFs and the Bootstrapping scheme. In this case, it is assumed that a role of performing a process for discovering a peer communication device by using an SDF and a role of performing public key sharing in the Bootstrapping scheme are determined so as to establish a connection. When the respective roles of the communication devices are determined and a connection process is performed, the users need to perform various kinds of settings (for example, input operations), etc., with these roles in mind. This is a troublesome task for users, and setting errors or the like could occur. Thus, there is room for further consideration in the connection process performed when a communication device directly connects to a peer communication device.

### SUMMARY

An aspect of the present disclosure is directed to providing a technique for properly establishing a connection when a communication device directly connects to a peer communication device.

According to an aspect of the present disclosure, a communication device is capable of executing a service by directly connecting to another communication device, and the communication device includes an operation control unit configured to cause the communication device to simultaneously or alternately operate as a search device that searches for the service and as an advertising device that reports the service, and a transmission unit configured to transmit a first frame that includes first information indicating whether the communication device operates as the search device or as the advertising device and second information relating to connection setup with the another communication device in a case where the communication device simultaneously or alternately operates as the search device and as the advertising device.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a configuration of a wireless communication system according to an embodiment.

FIG. 2 illustrates an example of a hardware configuration of a communication device according to the embodiment.

FIG. 3 illustrates an example of a functional configuration of the communication device according to the embodiment.

FIG. 4 illustrates an example of a processing sequence performed by communication devices according to the embodiment.

FIG. 5 illustrates an example of an operation flow of the communication device according to the embodiment.

### DESCRIPTION OF THE EMBODIMENTS

Hereinafter, embodiments will be described in detail with reference to the accompanying drawings. The following embodiments do not limit the contents described in the scope of claims. Although a plurality of features are described in the embodiments, all of the plurality of features are not necessarily essential to the present disclosure, and a plurality of features may be combined as desired. Furthermore, in the accompanying drawings, the same reference characters are given to the same or similar components, and redundant description will be omitted.

### Embodiment

### System Configuration

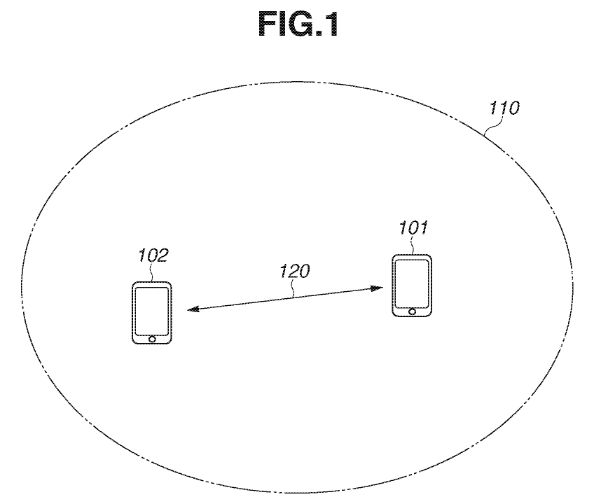

FIG. 1 illustrates an example of a configuration of a wireless communication system according to an embodiment. FIG. 1 illustrates a wireless communication network (which may be abbreviated as “wireless network” or “network”) 110 formed in the present wireless communication system.

The present wireless communication system includes two or more communication devices. For example, as illustrated in FIG. 1, the present wireless communication system may include a communication device 101 and a communication device 102. When the communication device 101 and the communication device 102 are not distinguished from each other, each of these communication devices may be referred to as “communication device 100”.

The communication device 100 may be a wireless communication device capable of performing wireless communication in accordance with the IEEE 802.11 series of standards including the IEEE 802.11bn standard. The communication device 100 may have functions of an Access Point (AP) and a station (STA) compliant with the IEEE 802.11 series of standards. IEEE stands for “Institute of Electrical and Electronics Engineers”.

The IEEE 802.11bn standard may also be referred to as “UHR standard”. UHR stands for “Ultra High Reliability”. The IEEE 802.11 series of standards may include the IEEE 802.11a/b/g/n/ac/ax/be standards. These standards may be referred to as “legacy standards”. That is, the communication device 100 may support at least one legacy standard in addition to the IEEE 802.11bn standard. Conversely, the communication device 100 may support at least one legacy standard and may not support the IEEE 802.11bn standard.

The wireless network 110 is constructed by one of the communication device 101 and the communication device 102 that use a Group Owner (GO) function of Wi-Fi Direct (WFD). In the constructed wireless network 110, a wireless communication link 120 is established between the communication device 101 and the communication device 102, and wireless communication is performed. When any one of the communication device 101 and the communication device 102 operates by using the GO function, the other communication device joins the wireless network 110 by using a Client (CL) function of WFD.

The communication device 100 may support another communication standard such as Bluetooth®, NFC, UWB, ZigBee®, or MBOA, in addition to the IEEE 802.11 series of standards. NFC stands for “Near Field Communication”, UWB stands for “Ultra-Wideband”, and MBOA stands for “Multiband OFDM Alliance”. The UWB can be applied to wireless USB, wireless 1394, WiNET, etc. The communication device 100 may support the communication standards of wired communication such as a wired LAN.

The communication device 100 may be any electronic device such as a smartphone, a tablet, a mobile phone, a personal computer (PC), a video camera, a headset, a printer, a display, or the like. However, the communication device 100 is not limited thereto, and may be an information processing device such as a wireless chip capable of executing wireless communication compliant with the IEEE 802.11bn standard.

The communication device 100 may communicate by using wireless signals in a frequency band such as a 2.4 GHz band, a 3.6 GHz band, a 5 GHz band, or a 6 GHz band. Alternatively, the communication device 100 may communicate by using wireless signals in a frequency band such as a 45 GHz band or a 60 GHz band, which are called millimeter waves. However, examples of the frequency band used by the communication device 100 are not limited thereto. For example, the communication device 100 may communicate in a Sub1 GHz band. Further, the communication device 100 may communicate by using a bandwidth of 20 MHz, 40 MHz, 80 MHz, 160 MHz, 320 MHz, 540 MHz, 640 MHz, 1080 MHz, or 2160 MHz. However, examples of the bandwidth used by the communication device 100 are not limited thereto. For example, the communication device 100 may use a 240 MHz bandwidth or a 4 MHz bandwidth. The IEEE 802.11 series of standards define the frequency channels that use a 20 MHz bandwidth as the basic channels in frequency bands such as 2.4 GHz, 5 GHz, and 6 GHz bands. In addition, these standards define a plurality of channels available in each of the frequency bands of 2.4 GHz, 5 GHz, and 6 GHz bands. Further, in these standards, a certain channel can be used in combination with another adjacent channel. According to the present embodiment, using a certain channel in combination with another adjacent channel may be referred to as “channel bonding”. A channel or a bundle of channels formed by two or more channels adjacent to each other may be referred to as “communication link” (or simply “link”). That is, one link formed by two channels each having a 20 MHz bandwidth uses a 40 MHz bandwidth. The communication device 100 may be an STA Multi-Link device (MLD) or an AP MLD that supports a Multi-Link, which simultaneously establishes a plurality of links to perform communication.

### Device Configuration

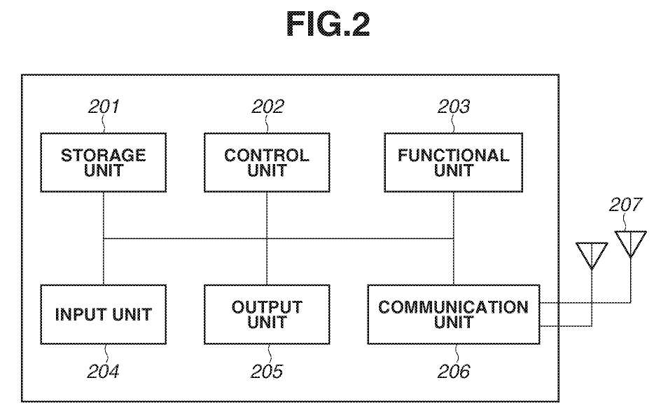

FIG. 2 illustrates an example of a hardware configuration of the communication device 100 according to the present embodiment. The communication device 100 includes a storage unit 201, a control unit 202, a functional unit 203, an input unit 204, an output unit 205, a communication unit 206, and antennas 207. The communication device 100 may have a plurality of antennas 207 as illustrated FIG. 2, or may have one antenna 207.

The storage unit 201 includes one or more memories such as a ROM and a RAM, and stores computer programs for performing various kinds of operations, which will be described below, and various kinds of information such as communication parameters for wireless communication. ROM stands for “Read-Only Memory”, and RAM stands for “Random Access Memory”. Other than the memories such as a ROM and a RAM, a storage medium such as a flexible disk, a hard disk, an SSD, an optical disk, a magneto-optical disk, a CD-ROM, a CD-R, a magnetic tape, a nonvolatile memory card, or a DVD may be used as the storage unit 201. SSD stands for “Solid State Drive”. CD-ROM stands for “Compact Disc Read-Only Memory”, CD-R stands for “Compact Disc Recordable”, and DVD stands for “Digital Versatile Disc”. The storage unit 201 may include a plurality of memories and the like. The storage unit 201 can store setting information entered to the communication device 100 by a user, the remaining amount of battery included in the communication device 100, information about the state of the communication device 100, such as whether a power saving operation is being executed, etc.

The control unit 202 includes one or more processors such as a CPU and an MPU, and controls the entire communication device 100 by executing computer programs stored in the storage unit 201. CPU stands for “Central Processing Unit”, and MPU stands for “Micro Processing Unit”. The control unit 202 may control the entire communication device 100 in cooperation with the computer programs stored in the storage unit 201 and an Operating System (OS). The control unit 202 generates data and signals (e.g., radio frames) that are transmitted when communication device 100 communicates with another communication device. The control unit 202 may include a plurality of processors such as multi-core processors, and the plurality of processors may control the entire communication device 100.

The control unit 202 controls the functional unit 203 to execute predetermined processes such as wireless communication, imaging, printing, and photographing. The functional unit 203 is hardware with which the communication device 100 executes the predetermined processes. For example, when the communication device 100 is a camera, the functional unit 203 is an imaging unit, and performs an imaging process. For example, when the communication device 100 is a printer, the functional unit 203 is a printing unit, and performs a printing process. For example, when the communication device 100 is a projector, the functional unit 203 is a projection unit, and performs a projection process. The data processed by the functional unit 203 may be data stored in the storage unit 201 or data obtained by communicating with another communication device via the communication unit 206, which will be described below.

The input unit 204 receives various kinds of operations from the user. The output unit 205 outputs various kinds of information to the user via a monitor screen or a speaker. The output unit 205 may output information displayed on the monitor screen, or may output audio via the speaker or vibration, for example. Both the input unit 204 and the output unit 205 may be implemented by one module such as a touch panel. Each of the input unit 204 and the output unit 205 may be integrated with or separated from the communication device 100.

The communication unit 206 controls wireless communication compliant with the IEEE 802.11bn standard. The communication unit 206 may control wireless communication compliant with any of the IEEE 802.11 series of standards other than the IEEE 802.11bn standard, or may control wired communication such as a wired LAN. The communication unit 206 controls the antennas 207 to transmit and receive signals for wireless communication generated by the control unit 202. The communication unit 206 may include a plurality of communication circuits corresponding to a plurality of links. When the communication device 100 supports the NFC standard, the Bluetooth standard, etc., in addition to the IEEE 802.11bn standard, the communication device 100 may control wireless communication compliant with these communication standards. In addition, when the communication device 100 can execute wireless communication compliant with a plurality of communication standards, the communication device 100 may be configured to include communication units and antennas corresponding to their respective communication standards separately. The communication device 100 communicates data such as image data, document data, or video data to a peer communication device via the communication unit 206.

The antennas 207 may be configured separately from the communication unit 206, or may be configured as one module together with the communication unit 206.

The antennas 207 are capable of communication in the 2.4 GHz band, the 5 GHz band, the 6 GHz band, etc. According to the present embodiment, there may be two or more antennas. When the communication unit 206 includes a plurality of communication units, different antennas may correspond to different communication units. Alternatively, a different antenna may be provided for each frequency band.

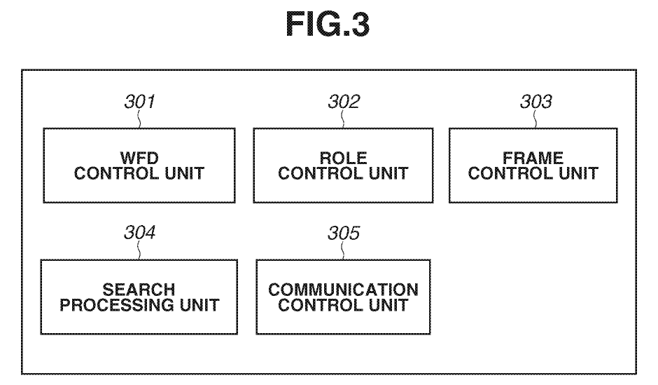

FIG. 3 illustrates an example of a functional configuration of the communication device 100 according to the present embodiment. The communication device 100 includes a WFD control unit 301, a role control unit 302, a frame control unit 303, a search processing unit 304, and a communication control unit 305.

The WFD control unit 301 performs control operations relating to WFD. For example, the WFD control unit 301 discovers a peer device by using a Probe Request, a Probe Response, a Service Discovery Frame (SDF), etc., and controls processes for establishing a connection. Examples of the processes controlled or executed by the WFD control unit 301 include an SDF process, a Bootstrapping process, a GO Negotiation process, etc.

The role control unit 302 causes the communication device 100 to operate as a seeker that searches for a service and to operate as an advertiser that reports a service. For example, the role control unit 302 causes the communication device 100 to simultaneously operate as a search device that searches for a service and as an advertising device that reports a service. In addition, for example, the role control unit 302 may cause the communication device 100 to alternately operate as a search device that searches for a service and as an advertising device that reports a service. Further, for example, when a predetermined condition is satisfied, the role control unit 302 causes the communication device 100 to operate as either the search device that searches for a service or the advertising device that reports a service. For example, when the counterpart to the communication device 100 can be determined to be a counterpart that executes the service by establishing a WFD connection, the role control unit 302 may determine that the predetermined condition has been satisfied. In addition, the role control unit 302 decides (e.g., or determines) a role for public key sharing in the Bootstrapping scheme based on whether the communication device 100 operates as an advertising device that reports a service or as a search device that searches for a service, and causes the communication device 100 to operate in the determined role. To share a public key in the Bootstrapping scheme, for example, public key information may be included in a QR code and may be shared. In this case, the roles for the public key sharing in the Bootstrapping scheme include a role of displaying a QR code (e.g., QR-code Display) and a role of scanning the QR code (e.g., QR-code Scan). Other than the method using a QR code, there is a method in which a public key is shared by using a PIN code. In this case, the roles for the public key sharing in the Bootstrapping scheme include, for example, a role of displaying a PIN code and a role of inputting a PIN code. There is also a method in which a public key is shared by using a passphrase or a numerical value. In this case, too, the roles include a role of displaying a passphrase or a numerical value and a role of inputting a passphrase or a numerical value. The role control unit 302 is an example of operation control means, an operation control unit, (e.g., role) determination means, a (e.g., role) determination unit, or the like.

The frame control unit 303 receives an instruction from the WFD control unit 301 and generates a frame.

In addition, the frame control unit 303 analyzes a received frame and performs a process relating to the WFD control.

The search processing unit 304 causes the communication control unit 305 to transmit or receive a target frame (for example, an SDF) based on the role determined by the role control unit 302, and performs a process for detecting a peer device.

The search processing unit 304 is an example of discovery means, a discovery unit, or the like.

The communication control unit 305 transmits a frame generated by the frame control unit 303. The communication control unit 305 outputs a received frame to the frame control unit 303. The communication control unit 305 performs a connection process with a peer device in accordance with connection parameters obtained by the WFD control unit 301. Examples of the processes controlled or executed by the communication control unit 305 may include an Authentication process, an Association process, and a 4-Way-Hand-Shake (4WHS) process. The communication control unit 305 is an example of transmission means, a transmission unit, reception means, a reception unit, transmission/reception means, a transmission/reception unit, communication means, a communication unit, or the like.

### Operations

Next, various kinds of operations such as a processing sequence in the wireless communication system and a flow of the process executed by the communication device 101 described above will be described.

### Overall Sequence

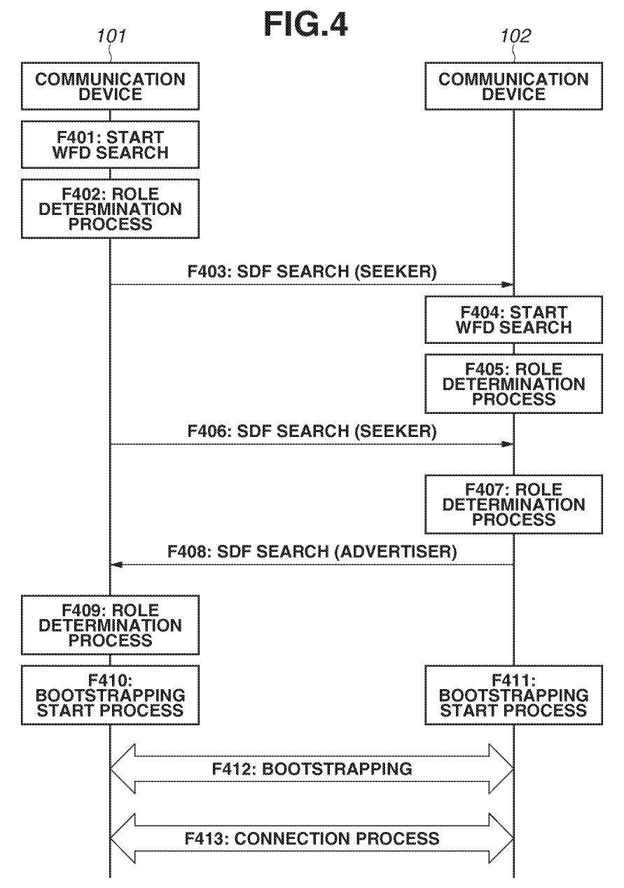

FIG. 4 illustrates an example of a processing sequence performed by the communication devices 101 and 102. FIG. 4 illustrates an example of a processing sequence in which the communication device 101 discovers the communication device 102, which is a peer device, and establishes a connection with the communication device 102 in accordance with an instruction from the user or an application in a WFD process.

Upon receiving an instruction to discover a peer device from the user or the application, the communication device 101 starts searching for a peer device by WFD (F401). For example, the output unit 205 of the communication device 101 displays a button (for example, a button indicating “Wi-Fi Direct”) for executing a process for discovering a WFD peer device. Next, the input unit 204 of the communication device 101 receives an input (e.g., a discovery instruction) indicating that the user has selected (e.g., pressed) the button indicating “Wi-Fi Direct” or the button indicating information related to the WFD operation. Alternatively, the input unit 204 of the communication device 101 may receive a voice input (e.g., a discovery instruction) indicating execution of Wi-Fi Direct. The discovery instruction may be issued based on the service to be executed. For example, when the user decides the service to be executed (e.g., execution service) and a target application associated with the execution service is activated, the communication device 101 may receive an instruction to discover a peer device from the application.

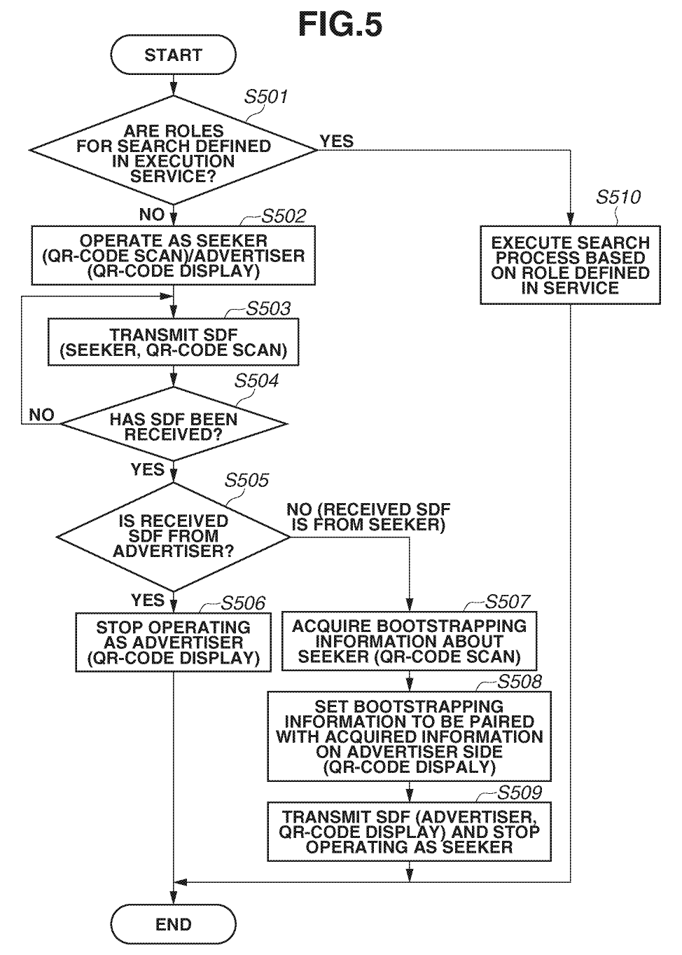

Upon receiving the instruction to discover a peer device, the communication device 101 starts a detection process for detecting a peer device (e.g., the communication device 102). First, the communication device 101 performs a role determination process necessary for the detection process (F402). While the role determination process will be described in detail with reference to FIG. 5, the outline of the role determination process will be described below.

First, the communication device 101 performs the role determination process based on the service to be executed. In this process, the communication device 101 determines the role (e.g., the advertiser or the seeker) in the WFD peer device detection process, as well as the role in a public-key sharing method in the Bootstrapping scheme. When each role is defined in advance in the service to be executed, the communication device 101 operates in accordance with the roles defined in the service. However, depending on the service to be executed, the communication device 101 or the communication device 102 may select its connection destination peer device, and may connect to this selected peer device. The advertiser plays a passive role of reporting its service, and thus, the role of the seeker is more suitable for actively discovering a connection destination peer device. Therefore, to select a connection destination peer device, the communication device 101 can operate as the seeker. Depending on the service to be executed, there are cases where both devices can select a connection destination peer device. For example, when executing a service such as image sharing, each of the devices may operate as the sender of an image and the receiver of an image. The same applies to a case where both devices execute a service in an equal relationship. When executing such service, a single communication device can operate as the advertiser and the seeker. In the present embodiment, it is assumed that such service is executed, and that each of the communication device 101 and the communication device 102 operates as both the advertiser and the seeker.

In the public-key sharing method in the Bootstrapping scheme used in a WFD connection process, a communication device determines in which role the communication device will operate in relation to the roles as the advertiser and the seeker, based on a sharing method that can be implemented by the communication device. For example, in the public-key sharing method using a QR code, there are a role of displaying a QR code and a role of scanning the QR code. The advertiser is assumed to operate as the device that displays a QR code, and the seeker is assumed to operate as the device that scans the QR code. The determination of these roles is merely an example. How the roles of the advertiser and the seeker are determined in the public-key sharing method is not limited to this example. The advertiser may operate as the device that scans the QR code, and the seeker may operate as the device that displays the QR code. Further, for example, the roles in the public-key sharing method may be determined based on the service to be executed. Any determination method may be used, as long as the roles of the advertiser and the seeker in the public-key sharing method are uniquely determined. In this way, the communication device performs the control operation such that the advertiser and the seeker have different roles in the public-key sharing method.

The communication device 101 starts to operate based on the roles determined in the role determination process. As described above, in the present embodiment, it is assumed that the communication device 101 has both the roles as the advertiser and the seeker. In addition, in the present embodiment, it is assumed that the public-key sharing method using a QR code is used in the Bootstrapping scheme. Further, it is assumed that the communication device 101 operates as the device that displays a QR code when the communication device 101 operates as the advertiser, and operates as the device that scans a QR code when the communication device 101 operates as the seeker.

The communication device transmits an SDF that includes information indicating whether the communication device is operating as the advertiser or the seeker (e.g., information indicating that the communication device is operating as the advertiser or information indicating that the communication device is operating as the seeker). The communication device also transmits an SDF that includes information (e.g., also referred to as “Bootstrapping information”) indicating its role in the public-key sharing method used in the Bootstrapping scheme. The Bootstrapping information is an example of information relating to connection setup with a peer device, connection setup information, or the like. The SDF also includes the identification information (e.g., identifier, ID) about the service to be executed.

The process for transmitting and receiving the SDFs is performed on a specific channel. For example, channel 6 is used as the specific channel for transmitting and receiving the SDFs. The SDF transmission and reception process may be executed on a plurality of channels. Alternatively, the channel on which the SDF transmission and reception process is executed may be defined in advance based on the service to be executed.

As the advertiser, the communication device waits to receive an SDF from another communication device operating as a seeker. Instead of waiting to receive an SDF, the communication device may periodically transmit an SDF for the purpose of advertising that the communication device is operating as an advertiser capable of executing a predetermined service. This SDF is transmitted to a broadcast address. Alternatively, this SDF may be transmitted to a specified multicast address associated with the service.

As the seeker, the communication device 101 actively transmits an SDF and performs a process for searching for a communication peer device (F403).

Similarly, when the communication device 102 receives an instruction to discover a peer device, the communication device 102 starts searching for a WFD peer device (F404). Next, the communication device 102 performs the role determination process (F405). The role determination process in F405 is performed in the same manner as the role determination process (F402) performed by the communication device 101.

As a result of F404, according to the present embodiment, the communication device 102 also has the roles of the advertiser and the seeker. The communication device 102 operates as a device that displays a QR code while operating as the advertiser, and the communication device 102 operates as a device that scans a QR code while operating as the seeker.

It is assumed that the communication device 102 receives the SDF transmitted by the communication device 101 as the seeker (F406). The SDF transmitted and received in F406 includes information indicating that the communication device 101 can operate with the role of scanning a QR code in the public-key sharing method in the Bootstrapping scheme.

Upon receiving the SDF transmitted from the seeker, the communication device 102 performs the role determination process, which will be described below with reference to FIG. 5 (F407). The communication device 102 transmits an SDF as the advertiser in the target service to the communication device 101 in response to the received SDF based on a function that is operated in the advertiser (F408). The SDF transmitted and received in F408 includes information indicating that the communication device 102 can operate with the role of displaying a QR code in the public-key sharing method in the Bootstrapping scheme. In the present embodiment, it is assumed that the communication device 102 has stopped operating as the seeker in the role determination process in F407.

Next, upon receiving the SDF from the communication device 102, the communication device 101 performs the role determination process, which will be described below with reference to FIG. 5 (F409). In the present embodiment, it is assumed that the communication device 101 has stopped operating as the advertiser in the role determination process in F409.

In the present embodiment, it is assumed that, at this point, the communication device 101 and the communication device 102 both have determined that they are peer devices with which they are to be connected.

The communication device 101 and the communication device 102 perform the Bootstrapping process based on SDF information respectively received by the devices (F410, F411, and F412).

Each SDF may include a plurality of public-key sharing methods in a plurality of Bootstrapping schemes. For example, when the communication device can operate as an advertiser device that displays a QR code, that displays a PIN code, and that displays a passphrase, this information may be included in an SDF from the advertiser. Similarly, when the communication device can operate as a seeker device that scans a QR code, that inputs a PIN code, and that inputs a passphrase, this information may be included in an SDF from the seeker.

In this case, the communication device may transmit and receive a Provision Discovery (PD) Request/Response frame in WFD.

The roles of both the communication device 101 and the communication device 102 in the public-key sharing method in the Bootstrapping process are uniquely determined through transmission and reception of the PD Request/Response frames. For example, when the communication device 101 operates as the seeker after the communication device 101 and the communication device 102 complete the exchange of the SDFs, the communication device 101 operates as follows. That is, the communication device 101 transmits, to the communication device 102, a PD Request frame including information indicating that the communication device 101 operates as a device that scans a QR code. In this way, the role of the communication device 101 in the public-key sharing method is uniquely determined. Based on this determination, the role of the communication device 102 that has received the PD Request, the role being paired with that of the communication device 101 in the public-key sharing method (e.g., in this case, a device that displays a QR code), is also determined.

In the SDF transmission and reception process, in a case where the roles in the public-key sharing method in the Bootstrapping scheme are already uniquely determined between the communication device 101 and the communication device 102, there is no need to perform the transmission/reception process of the PD Request and Response frames. In this case, the Bootstrapping process may be started only with the exchange of the SDFs.

When the Bootstrapping process is started, the public key is shared based on the roles in the public-key sharing method in the Bootstrapping scheme, the roles having been determined by both the devices. In the public key sharing, setting items necessary for performing wireless communication are included as other information (e.g., parameters) in the QR code to be displayed. Examples of the setting items include an SSID, an encryption method, an encryption key, an authentication method, an AKM, a BSSID, and a MAC address. SSID stands for “Service Set Identifier”, and AKM stands for “Authentication and Key Management”. BSSID stands for “Basic Service Set Identifier”, and MAC stands for “Medium Access Control”. The AKM is a value indicating which authentication protocol or key exchange algorithm is used at the time of communication.

Subsequently, in accordance with the determined public-key sharing method, the communication device 101 and the communication device 102 perform an exchange process of parameters necessary for constructing the wireless network 110 in their respective roles.

Next, the communication device 101 and the communication device 102 perform GO Negotiation to determine which of the communication devices operates as “GO” and to determine a channel on which the “GO” operates. In the GO Negotiation, to authenticate each other, PASN (Pre-association Security Negotiation) is performed in accordance with the parameters exchanged in the Bootstrapping process.

By executing the series of connection processes (F413) described above, a wireless connection is established between the communication device 101 and the communication device 102.

### Peer Device Discovery and Role Determination Process

An example of a process from the discovery of a peer device to the determination of the roles will be described with reference to FIG. 5. FIG. 5 illustrates an example of an operation flow of the communication device 100, and illustrates an example of an operation flow performed when a peer device is detected. The flow illustrated in FIG. 5 is started when a user or an application specifies a predetermined service and issues a request to discover a peer device by using Wi-Fi Direct. Alternatively, the flow illustrated in FIG. 5 may be started when the detection of a peer device is instructed without specifying any standard.

The communication device 100 receives an instruction to discover a peer device from the user or the application. For example, upon receiving the instruction, the output unit 205 of the communication device 101 displays a button (for example, a button indicating “Wi-Fi Direct”) for executing the process for discovering a WFD peer device. Next, the input unit 204 of the communication device 101 receives an input (e.g., a discovery instruction) indicating that the user has selected (e.g., pressed) the button indicating “Wi-Fi Direct” or the button indicating information related to the WFD operation. Alternatively, the input unit 204 of the communication device 101 may receive a voice input (e.g., a discovery instruction) indicating execution of Wi-Fi Direct. The communication device 100 may receive an instruction to discover a peer device when the user specifies a service using Wi-Fi Direct (for example, when a target application associated with a service is activated).

First, in step S501, the communication device 100 determines whether the roles for search, that is, the advertiser and the seeker, in the specified execution service are defined in advance in the service. In a case where the roles are defined in advance in the service (Yes in step S501), the process proceeds to step S510. In a case where the roles are not defined in advance in the service (No in step S501), the process proceeds to step S502.

In step S510, the communication device 100 performs a process for searching for a peer device based on the roles defined in the service. Next, the process proceeds to END.

In step S502, the communication device 100 starts to operate as the advertiser and the seeker. As described above, in the present embodiment, it is assumed that a QR code is used as the public-key sharing method. When operating as the advertiser, the communication device 100 operates as the device that displays a QR code. When operating as the seeker, the communication device 100 operates as the device that scans a QR code. As for the role determination method in the public-key sharing method, in the present embodiment, it is assumed that the roles are uniquely determined. However, as described above, the present disclosure is not limited thereto. Next, the process proceeds to step S503.

In step S503, as the seeker, the communication device 100 transmits an SDF for discovering a peer device. The SDF includes information indicating that the communication device 100 is operating as the seeker and is operating as the device that scans a QR code in the Bootstrapping scheme. The communication device 100 transmits the SDF by broadcast or multicast. Alternatively, when the communication device 100 has received an SDF of an advertiser from a peer device, the communication device 100 may identify this peer device and transmit an SDF to the peer device by unicast. Next, the process proceeds to step S504.

In step S504, the communication device 100 waits to receive an SDF transmitted by another communication device. This reception standby for an SDF includes both standby for receiving a response to the SDF transmitted as the seeker and standby for receiving an SDF transmitted from another communication device operating as the advertiser. In a case where the communication device 100 has received the SDF (Yes in step S504), the process proceeds to step S505.

In step S505, the communication device 100 analyzes the information included in the received SDF, and determines whether the another communication device that has transmitted the received SDF is operating as the advertiser. In a case where the another communication device is operating as the advertiser (Yes in step S505), the process proceeds to step S506. In a case where the another communication device is not operating as the advertiser, that is, operating as the seeker (No in step S505), the process proceeds to step S507.

In step S506, the communication device 100 stops operating as the advertiser, and determines to operate only as the seeker. When the communication device 100 determines to operate only as the seeker, the communication device 100 may transmit an SDF in response to the received SDF to the another communication device that has transmitted the received SDF. In this case, the communication device 100 includes, in this response SDF, information indicating that the communication device 100 is operating as the seeker and is operating as the device that scans the QR code, and transmits the response SDF. In this way, for example, in a case where the another communication device that had transmitted the received SDF has not received the SDF transmitted by the communication device 100 as the seeker, the another communication device can acquire information indicating that the communication device 100 operates as the device that scans a QR code, etc.

In a case where the service identifier included in the received SDF does not match the service identifier specified by the communication device 100, the communication device 100 may discard the received SDF, and the process may return to step S504. In addition, in a case where the communication device 100 makes a determination as follows based on the information indicating the role in the public-key sharing method used in the Bootstrapping scheme, the information being included in the received SDF, the communication device 100 may also discard the received SDF, and the process may return to step S504. That is, in a case where the communication device 100 determines that the communication device 100 cannot share the public key by using the public-key sharing method used when the communication device 100 operates as the seeker, the communication device 100 may discard the received SDF, and the process may return to step S504. In this case, the communication device 100 may switch the public-key sharing method used when the communication device 100 operates as the seeker so as to match the sharing method used by the peer device operating as the advertiser, the sharing method being included in the received SDF. Further, the communication device 100 may transmit an SDF that includes information indicating its role in this sharing method to the peer device as a response.

After step S506 is completed, the process proceeds to END.

In step S507, the communication device 100 analyzes the information included in the received SDF, and acquires information (e.g., Bootstrapping information) indicating the role of the peer device in the public-key sharing method in the Bootstrapping scheme. Next, the process proceeds to step S508.

In step S508, the communication device 100 operates as the advertiser and creates a response SDF. In this step, the communication device 100 includes, in the response SDF, information indicating the role that is paired with the role specified by the peer device as the Bootstrapping information. According to the present embodiment, the SDF of the peer device operating as the seeker includes information indicating that its role in the public-key sharing method is to operate as the device that scans the QR code. Therefore, the communication device 100 includes, in the response SDF, information indicating that the communication device 100 operates as the device that displays the QR code so as to be paired with the device that scans the QR code. Next, the process proceeds to step S509. In a case where the public-key sharing method reported in step S508 is a sharing method that the communication device 100 does not support, the communication device 100 may discard the target SDF, and the process may return to step S504.

In step S509, the communication device 100 transmits the SDF created in step S508 to the peer device as a response, and stops operating as the seeker. Next, the process proceeds to END.

The communication device 100 may stop operating as the advertiser or the seeker (S506 or S509) when a predetermined condition is satisfied. When the communication device 100 can uniquely determine that the communication device 100 operates as either the search device that searches for a service or the advertising device that reports a service with respect to its counterpart, the communication device 100 can determine that the predetermined condition is satisfied.

Additionally or alternatively, when the communication device 100 can determine that its counterpart executes a service by establishing a Wi-Fi Direct connection, the communication device 100 can determine that the predetermined condition is satisfied.

As described above, according to the present embodiment, when the communication device operates as both the search device and the advertising device of a service, the communication device determines the role in the public-key sharing method in the Bootstrapping scheme in accordance with the respective roles of the search device and the advertising device. Next, the communication device transmits an SDF that includes information indicating its corresponding role and performs a connection process. This enables the user to establish a connection without being aware of each role. Thus, the convenience of the user can be improved. As a result, the communication device can establish a proper connection when directly connecting to its peer communication device.

### Other Embodiments

The above-described embodiment has been described based on an example in which a peer device is detected between the communication device 101 and the communication device 102. However, the present disclosure is also applicable to a case where there are a plurality of peer devices. In addition, according to the present embodiment, the communication device 100 stops operating as either the advertiser or the seeker at the time when the communication device 100 detects its counterpart. However, the communication device 100 may stop operating as either the advertiser or the seeker at the time when the user selects a connection destination. For example, when the communication device 100 can detect a plurality of counterparts, the output unit 205 of the communication device 100 outputs a list of detected counterparts, and allows the user to select a counterpart that the user wishes to connect to from the output list. The communication device 100 may stop operating as either the advertiser or the seeker at the time when the user selects the counterpart. For example, when the counterpart selected by the user is the seeker, the communication device 100 may stop operating as the advertiser. Further, the communication device 100 may stop operating as the advertiser and the seeker at the time when the connection with the selected counterpart is established.

According to the above-described embodiment, the advertiser and the seeker are operated simultaneously during the counterpart detection process. However, the present disclosure is not limited to this example. A period in which the communication device 100 operates as each of the advertiser and the seeker may be defined as a predetermined time period, and the communication device 100 may alternately operate as the advertiser and the seeker.

As described above, the advertiser may periodically transmit an SDF so as to report its service by broadcast. For example, assuming that the communication device 102, which is the counterpart to the communication device 101, operates in the same manner as the communication device 101, the communication device 101 receives both an SDF of the advertiser and an SDF of the seeker from the identical device (e.g., the communication device 102). Whether the transmission sources of these SDFs are the identical device can be identified based on information that identifies the transmission source devices such as the MAC addresses included in the SDFs. In this case, the communication device 101 may transmit, as a response, an SDF to be paired, depending on the SDF received earlier. For example, in a case where the communication device 101 receives an SDF of the advertiser from the communication device 102, which is the transmission source, first, the communication device 101 operates as the seeker and transmits a response SDF to the communication device 102. The communication device 101 may discard a SDF received later without responding to the SDF received later.

In addition, in the above-described embodiment, a case in which the public-key sharing method in the Bootstrapping scheme is used has been described. In the public-key sharing method, two devices have their respective roles that are paired with each other. However, the present disclosure is not limited to this case. For example, a method in which two devices share a public key by performing the same operation, such as pressing a button, may be used. In this case, the SDFs transmitted by the advertiser and the seeker may include information indicating the same public-key sharing method.

A storage medium storing software program codes implementing the above-described functions may be supplied to a system or a device, and a computer (e.g., CPU, MPU) of the system or the device may read and execute the program codes stored in the storage medium. In this case, the program codes read from the storage medium implement the functions of the above-described embodiment, and the storage medium storing the program codes constitutes the above-described device.

Examples of the storage medium that can be used for supplying the program codes include a flexible disk, a hard disk, an optical disk, a magneto-optical disk, a CD-ROM, a CD-R, a magnetic tape, a nonvolatile memory card, a ROM, and a DVD.

The above-described functions may be implemented not only by executing the program codes read by the computer, but also by causing the OS running on the computer to partially or entirely perform actual processing based on the instructions of the program codes.

Further, the program codes read from the storage medium are written in a memory provided in a function expansion board inserted into the computer or a function expansion unit connected to the computer.

Based on the instructions of the program codes, the CPU included in the function expansion board or the function expansion unit may partially or entirely perform actual processing to implement the above-described functions.

The present disclosure can also be achieved by supplying a program that implements one or more functions of the above-described embodiments to a system or a device via a network or a storage medium and causing one or more processors in a computer of the system or the device to read and execute the program. The present disclosure can also be achieved by a circuit (for example, an Application Specific Integrated Circuit (ASIC)) that implements one or more functions.

The processing described with reference to the flowchart in the present disclosure may be partially implemented by hardware. For example, a dedicated circuit may be automatically generated on a Field Programmable Gate Array (FPGA) from a program for implementing each step by using a predetermined compiler. Alternatively, a Gate Array circuit may be formed in the same manner as in the FPGA, and may be implemented as hardware.

The names of the functional units, messages, parameters, fields, and the like described in the above-described embodiments may be changed to other names.

The order in the processing procedures, sequences, flowcharts, and the like of the above-described embodiments is not limited to the presented specific order. The order may be rearranged, or additional steps may be added, as long as there is no contradiction.

According to an aspect of the present disclosure, a communication device can establish a proper connection when directly connecting to a peer communication device.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-071452, filed Apr. 23, 2025, which is hereby incorporated by reference herein in its entirety.

What is claimed is:

1. A communication device capable of executing a service by directly connecting to another communication device, the communication device comprising:
at least one memory that stores a set of instructions; and
at least one processor that executes the instructions, the instructions, when executed, causing the communication apparatus to perform operations comprising:
causing the communication device to simultaneously or alternately operate as a search device that searches for the service and as an advertising device that reports the service; and
transmitting a first frame that includes first information indicating whether the communication device operates as the search device or as the advertising device and second information relating to connection setup with the another communication device in a case where the communication device simultaneously or alternately operates as the search device and as the advertising device.

2. The communication device according to claim 1,
wherein the transmitting a second frame including the first information and the second information, and
wherein the first information included in the first frame indicates that the communication device operates as the search device and the first information included in the second frame indicates that the communication device operates as the advertising device.

3. The communication device according to claim 2, wherein the second information included in the first frame and the second information included in the second frame are different from each other.

4. The communication device according to claim 1, wherein the operations further comprise receiving, from the another communication device, a third frame including third information indicating that the another communication device operates as the advertising device after transmitting the first frame,
wherein the first information indicates that the communication device operates as the search device.

5. The communication device according to claim 4,
wherein the third frame further includes fourth information relating to connection setup with the communication device, and
wherein the second information and the fourth information are different from each other.

6. The communication device according to claim 4, wherein, upon receiving the third frame, the causing causes the communication device to operate only as the search device.

7. The communication device according to claim 2, wherein the operations further comprise receiving, from the another communication device, a fourth frame including fifth information indicating that the another communication device operates as the search device, before transmitting the second frame.

8. The communication device according to claim 7,
wherein the fourth frame further includes sixth information relating to connection setup with the communication device, and
wherein the second information included in the second frame and the sixth information are different from each other.

9. The communication device according to claim 7, wherein, upon receiving the fourth frame, the causing causes the communication device to operate only as the advertising device.

10. The communication device according to claim 1, wherein the second information is information relating to a public-key sharing method in a Bootstrapping scheme.

11. The communication device according to claim 1, wherein the first frame is a Service Discovery Frame (SDF).

12. The communication device according to claim 1, wherein the transmitting transmits the first frame by broadcast or multicast.

13. The communication device according to claim 1, wherein the transmitting transmits the first frame to the another communication device by unicast.

14. A control method of a communication device capable of executing a service by directly connecting to another communication device, the control method comprising:
causing the communication device to simultaneously or alternately operate as a search device that searches for the service and as an advertising device that reports the service; and
transmitting a first frame that includes first information indicating whether the communication device operates as the search device or as the advertising device and second information relating to connection setup with the another communication device in a case where the communication device simultaneously or alternately operates as the search device and as the advertising device.

15. A non-transitory computer-readable storage medium storing instructions that, when executed by a computer, cause the computer to perform a control method of a communication device capable of executing a service by directly connecting to another communication device, the control method comprising:
causing the communication device to simultaneously or alternately operate as a search device that searches for the service and as an advertising device that reports the service; and
transmitting a first frame that includes first information indicating whether the communication device operates as the search device or as the advertising device and second information relating to connection setup with the another communication device in a case where the communication device simultaneously or alternately operates as the search device and as the advertising device.
